(19) United States
(12) Patent Application Publication
(10) Pub. No.: US 2013/0208111 A1
(43) Pub. Date: Aug. 15, 2013

(54) FLIGHT RECORDER

(71) Applicants: Nicholas Kidd, New Milton (GB); Paul Chamberlain, Ferndown (GB)

(72) Inventors: Nicholas Kidd, New Milton (GB); Paul Chamberlain, Ferndown (GB)

(73) Assignee: Penny & Giles Aerrospace Limited, Chrisstchurch (GB)

(21) Appl. No.: 13/702,850

(22) PCT Filed: May 26, 2011
(86) PCT No.: PCT/GB11/00794

§ 371 Date: Apr. 25, 2013

(30) Foreign Application Priority Data
Jun. 8, 2010 (GB) 1009595.8

(51) Int. Cl. H04N 7/18

(52) U.S. Cl. CPC H04N 7/18
USPC 348/143

(57) ABSTRACT

The present invention describes a flight recorder for an aircraft with an instrument display panel for displaying aircraft status data to a pilot. The flight recorder comprises one or more sensors that monitor one or more flight conditions of the aircraft, a camera unit for providing image data and a data storage unit for storing the aircraft status data and image data from the camera. The flight recorder additionally comprises a control unit for monitoring the flight condition data supplied by the sensors.

This application relates to aviation flight recorders and in particular to aviation flight recorders for light aircraft.

Aviation cockpit voice and flight data recorders (sometimes called ‘black box’ recorders or flight recorders) are used to gather and retain pertinent information about the operation and status of aircraft during a flight. This information becomes a crucial component in case of an unexpected event or accident involving the aircraft.

Flight recorders are required, by international regulations, to be carried on certain aircraft, typically large or passenger carrying aircraft and are made to conform to international standards relating to protection from crash damage and fire; however other aircraft not currently covered by these international regulations, typically light aircraft, are not currently mandated to carry and use them. It is possible that regulations requiring flight recorders for light aircraft may be introduced in the near future.

Typically, the flight recorders used in large commercial aircraft continually monitor the current condition of the aircraft via a large number of cables and sensors located around the aircraft. Data signals from these sensors are fed into a flight data acquisition unit (FDAU) which sends the data to the flight data recorder. Typical examples of information sent to be stored on the flight data recorder include position, speed, altitude, engine speed and rudder position; however modern flight data recorders can track and store several hundred parameters.

Sound recordings of the pilot and co-pilot's voices, as well as from other microphones in the cockpit area are also recorded and may be sent to a separate second flight recorder, often called a Cockpit Voice Recorder (CVR) or to a combined Cockpit Voice and Flight Data Recorder (CVFDR).

The standards require that these flight recorders are designed to withstand very high temperatures, large impact forces and prolonged submersion in water, so as to survive the conditions that may arise either during or after a crash of a large aircraft.

The number of sensors and cabling and the size of the memory protection required make the use of conventional flight recorders in light aircraft impractical due to the large weight and bulk of the recorder. Conventional flight recorders are also expensive, partially due to their high durability.

U.S. Pat. No. 6,898,492 describes a flight data recorder for use with a light aircraft. The flight recorder is disclosed with built-in sensors to remove the need for external sensors and extensive cabling throughout an aircraft, however as the number of sensors determines the size and bulk of the flight recorder, a compromise is necessary.

It is an aim of the current invention to provide an improved flight recorder more suited to use for light aircraft.

According to a first aspect of the present invention, there is provided a flight recorder for an aircraft with an instrument display panel for displaying aircraft status data to a pilot. The flight recorder comprises one or more sensors that provide flight condition data of the aircraft, a camera unit that provides image data; a data storage unit storing the aircraft status data and image data from the camera; and a control unit that monitors the flight condition data supplied by the sensors.

Advantageously, the flight recorder is mountable within a cockpit area of the aircraft to allow the camera unit to generate an image or a series of images of an instrument display panel and any aircraft status data displayed thereupon. Additionally, the flight recorder may be configured to dynamically change the resolution and/or the rate at which the sensor data are read and recorded. and/or at which the image or series of images are generated. The flight recorder may also be configured to alter the resolution and/or the rate at which the sensor data are read and recorded, and/or at which the images or series of images are generated, when the control unit detects a change to one or more of the flight condition data obtained by the sensors. This may be an absolute change, or may be subject to a threshold value or range. Typically, the resolution of the sensor data or generated images or series of images is altered from a lower resolution to a higher resolution. Similarly, the rate of the sensor data or generated images or series of images is altered from a lower rate to a higher rate.

The sensor data may be provided as digital data having a resolution determined by a number of bits of a digital format of the sensor data. In this regard the digital format may be one to which the sensor data is converted in an analogue-to-digital converter. For example, the sensor data may be converted to, say, an 8-bit digital signal for low resolution and to a 24-bit digital signal for high resolution.

It may be appreciated that the sensors of the flight recorder may include audio sensors. In this instance, the flight conditions monitored by the sensors may include cockpit sounds and/or voices. Alternatively, or additionally the sensors may comprise one or more audio-input sensors configured to monitor the audio stream from the headset or headsets of the cockpit crew. The audio data from the audio sensors and/or the audio-input sensors may be recorded by the data storage unit.

The data storage unit may comprise multiple storage devices, wherein data elements or groups of data elements comprising sensor data or image data are partitioned and stored in different storage devices. Each storage device may contain a complete and continuous record of the stored sensor, audio and image data but at a slower recorded rate than is contained within all the storage devices combined.

According to another aspect of the invention, there is provided a method of recording aircraft flight data comprising the steps of providing a flight recorder unit, wherein the flight recorder unit contains a camera and a data storage unit for recording image data generated by the camera unit. Preferably, the method additionally comprises the steps of: locating the flight recorder unit within a cockpit area of an aircraft; and using the camera to generate an image or series of images of an instrument display panel and aircraft status data displayed thereupon. The resolution and/or the rate of images generated by the camera may be dynamically altered.

Advantageously, the method may further comprise monitoring a flight condition of an aircraft from one or more sensors in the flight recorder. The method may further comprise: detecting a change to one or more of the flight condition data; and dynamically altering the resolution and/or the rate at which the flight condition data are recorded and/or at which the image or series of images are generated on detecting a change to one or more of the flight condition data obtained by the sensors.

In this case, the method may comprise generating a lower resolution image or series of images and/or rate of images or series of images in the absence of a change to one or more of the flight condition data and generating a higher resolution image or series of images, and/or a higher rate of images or series of images, when a change to one or more of the flight condition data obtained by the sensors is detected.

Similarly, the method may include dynamically altering the resolution and/or the rate at which the sensor data are read and recorded. The resolution and/or the rate at which the sensor data are recorded may be altered when the control unit detects a change to one or more of the flight condition data obtained by the sensors. This may be an absolute change, or may be subject to a threshold value or range. Typically, the resolution of the sensor data is altered from a lower resolution to a higher resolution.

The images or series of images generated by the camera may form an interspersed series of different resolution images. For example, several high resolution images may be formed a second, with additional lower resolution images interspersed either thereafter or in-between the higher resolution images. The method may further comprise interlacing the image data to form an image of higher resolution from two or more lower resolution images.

By dynamically altering the resolution or rate at which sensor data and images are generated, the amount of storage or memory used to store the information is reduced and the system processing power required is reduced, allowing the use of smaller flight recorders more suited to use on a light aircraft. Additionally, critical data useful for the analysis of an incident or accident will be available at a higher rate or resolution at the time when the data is likely to be changing most rapidly. This dynamic change in resolution and/or rate may, for example, involve an increase in resolution or rate triggered by a detection of rapidly changing conditions, or “out of normal” conditions, and would typically occur for a short duration or until “normal” conditions return. Normal and out of normal conditions may be pre-defined, for example by set thresholds or limits to sensed conditions or rates of change of sensed conditions.

Additionally, cockpit audio such as voice or general noise may be recorded by means of an audio sensor. This audio sensor can be provided within the flight recorder unit as an integrated cockpit area microphone. This provides several advantages such as reduced complexity and reduced cost of installation. In addition the audio sensor may detect the headset audio stream from the pilot or other occupant and air traffic control radio communication using an input of the external audio. This audio data may then be stored by the flight recorder unit.

The data storage unit may comprise multiple storage devices, the method further comprising partitioning sensor data and/or image data into data elements or groups of data elements and storing the data elements or groups in different storage devices. The method may comprise storing a complete and continuous record of the stored sensor, audio and image data in each storage device but at a slower recorded rate than is contained in the data stored in all the storage devices combined.

The invention will now be described by way of example with reference to the accompanying drawings, in which like reference numerals designate like elements:

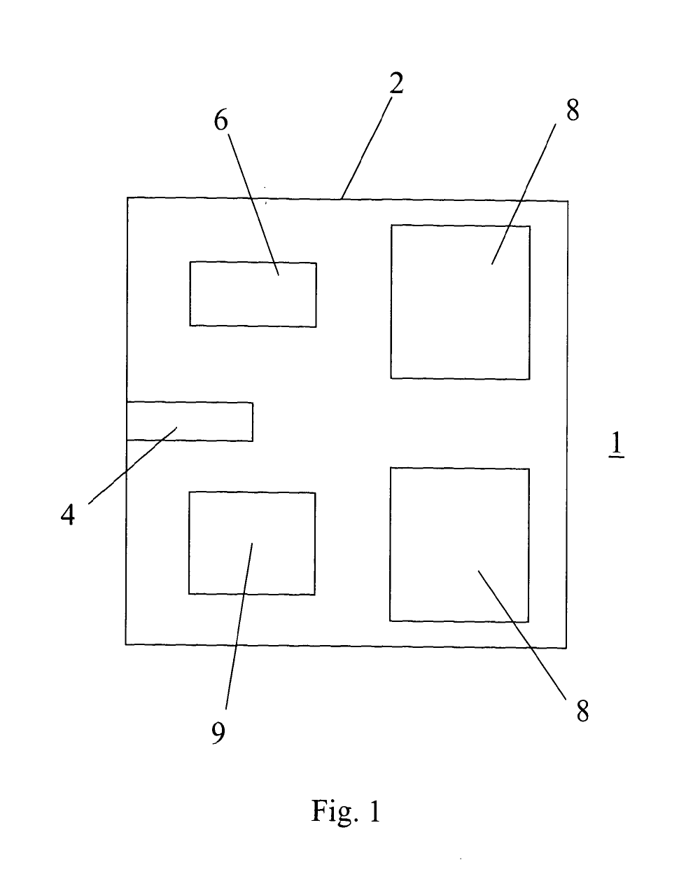

FIG. 1 is a schematic of a flight recorder in accordance with an embodiment of the present invention.

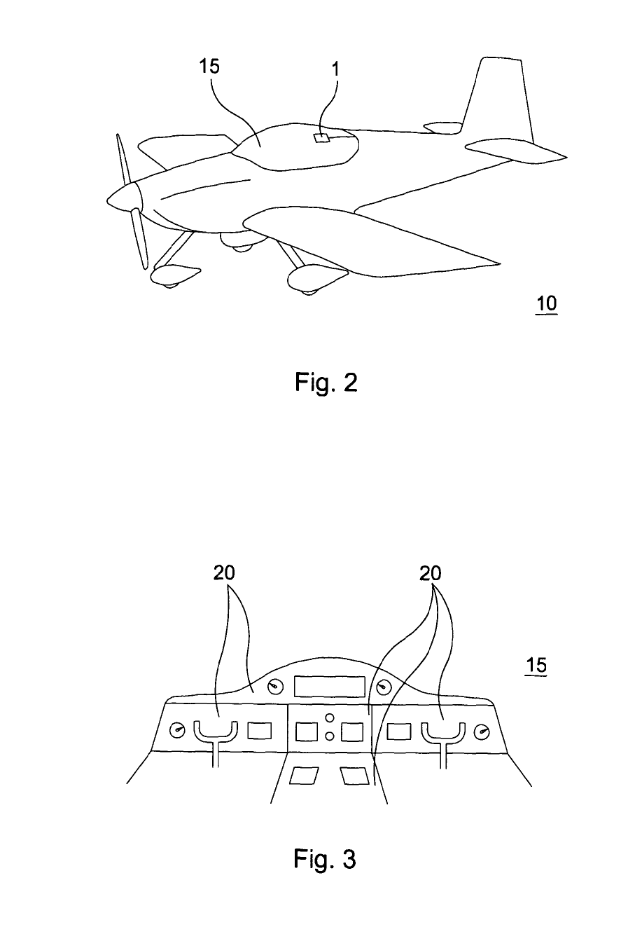

FIG. 2 illustrates an aircraft with a possible location for the flight recorder shown.

FIG. 3 is an illustration of an aircraft cockpit area as may be generated by a camera unit within a flight recorder embodiment.

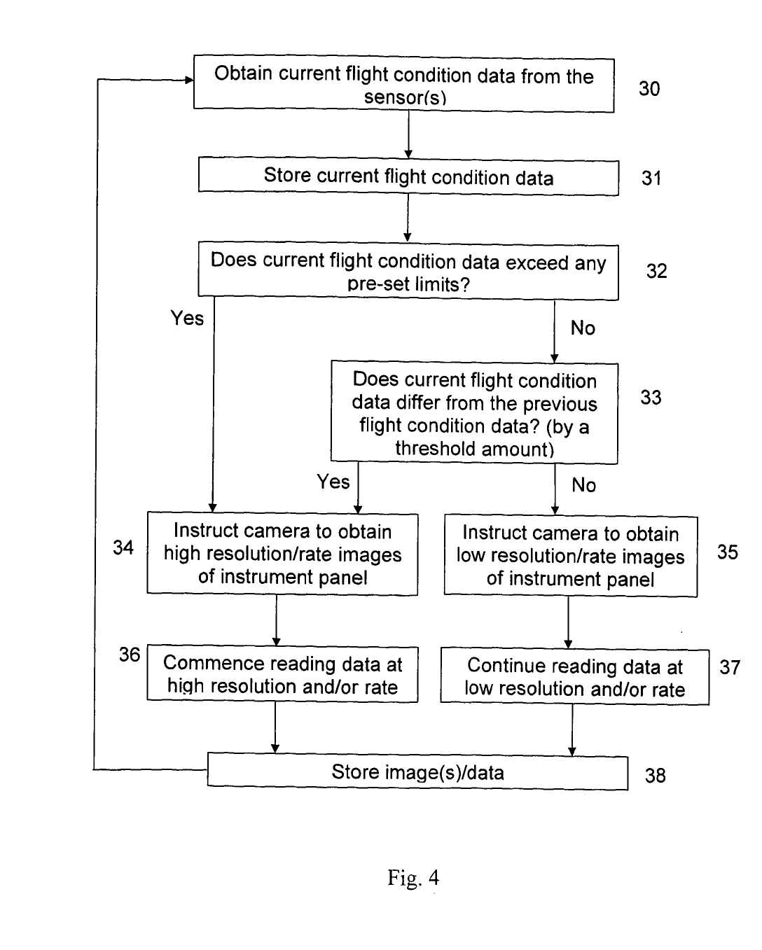

FIG. 4 is a flow chart illustrating a decision sequence that may be performed by the control unit, of a flight recorder embodiment.

In FIG. 1, a flight recorder 1 comprises a case 2 for housing a number of internal components. The case 2 provides stability for the components and is preferably configured to withstand impacts, fire, crush and submersion in fluid which may occur as a result of an unexpected event involving an aircraft. Typically, insulation is provided within the case to protect the components from fire and impact damage. It may be appreciated that the level of protection provided by the insulation should be appropriate for the type of aircraft, taking into account the operating envelope of a smaller aircraft i.e. slower speed, carrying less fuel when compared to larger, commercial aircraft. The flight recorder 1 contains a camera unit 4 that is configured to obtain digital images or series of images. Advantageously, the camera unit 4 is able to dynamically adjust the resolution of obtained images or series of images according to instructions from a control unit 6.

The control unit 6 is configured to obtain flight condition data from one or more sensors 8 located within the case 2 of the flight recorder 1. These sensors 8 provide details of flight conditions, for example the altitude, speed, pitch, roll or yaw of the aircraft, and may therefore take the form of gyroscopic, acceleration, compass and cabin pressure sensors, although it will be appreciated that any flight condition and associated sensor may be incorporated into the device. Although it is preferred for the sensors to be located in the same flight recorder unit, sensor data could also be provided by way of an external data link from sensors elsewhere on the aircraft. Typically parameters such as speed, elevation/altitude and position would be provided by means of an integrated GPS unit. The sensors 8 may also be configured to detect audio, for example. cockpit voices or noises, or may be able to receive audio from an external headset, microphone or air traffic control radio, for example from a headset worn by the pilot. Information recorded by the control unit 6 and the camera unit 4 is stored in a memory or a storage unit 9. This data may be stored in a compressed format in accordance with known protocols (for example JPG and MPEG compression for images, MP3 or WAV for audio).

Many of the components shown in FIG. 1 may be mounted outside of any fire or mechanical protection. It is the memory or storage unit 9 which needs to be recovered after a crash or an unexpected event involving an aircraft, and which it is most important to protect from fire and impact damage etc. Therefore the memory or storage unit 9 alone, may be encased locally inside case 2 with insulation and mechanical protection provided to protect the memory components.

FIG. 2 illustrates an aircraft 10 with a cockpit area 15. The flight recorder 1 is shown located within the cockpit area 15 and is positioned facing towards an instrument display panel 20 (see FIG. 3). It is an advantage of the current invention that the flight recorder 1 is lighter and of less bulk than conventional flight recorders, allowing it to be located in a greater variety of positions within the aircraft. The positioning of the flight recorder 1 is preferably located to allow a clear unobstructed image of the instrument display panel 20 for the camera unit 4.

FIG. 3 illustrates the interior of aircraft cockpit area 15. The cockpit area 15 includes one or more instrument display panels 20. The display panels 20 display aircraft status data to a pilot (not shown). The aircraft status data may include, for example, information relating to the altitude, aircraft speed, wind speed and position of the aircraft as well as information such as fuel level, engine temperature etc. that is relayed to the instrument display panels 20 by an array of detectors (not shown) located around the aircraft. When the flight recorder 1 is located within the cockpit area 15 and is positioned facing towards the instrument display panels 20, the camera unit 4 obtains an image or a series of images of the instrument display panels 20, which are then stored in the data storage unit 9.

It will be appreciated that the complexity, design and number of instrument display panels 20 may vary depending upon the type of aircraft used. It will also be appreciated that the number of detectors located around the aircraft and the amount of information supplied to the instrument display panels 20 are also dependent upon the individual aircraft. However, by suitable positioning, the camera unit 4 in the flight recorder 1 can capture and store images of the instrument display panels 20 without the need for separate sensor data being fed to the flight recorder 1, thus reducing the installation cost and weight in terms of external sensors and cable routing.

FIG. 4 shows a flowchart detailing a decision sequence that may be performed by the control unit 6. Initially, the flight recorder 1 is located within the cockpit area 15 of the aircraft 10, preferably in a position such as that shown in FIG. 2. During a flight and at step 30, the control unit 6 obtains one or more current flight condition data from the sensors 8. The sensor data is typically obtained via an analogue to digital converter, which provides the current data in a low resolution, for example 8-bit, digital data format. The control unit 6 then stores this current flight condition data either in the data storage unit 9 or in another form of memory, for example RAM (step 31). At this stage, while conditions are normal, the current flight data is stored at a low rate or frequency. Also, while the flight conditions are normal, the camera unit 4 may be configured to generate image data of the cockpit instrument display panel 20 at a low resolution and/or a low rate so that these image data are recorded. Typically a high resolution image will be captured every second, interspersed with lower resolution images. In this instance, during the absence of a significant change in flight conditions, the higher resolution images may be generated at a lower rate and interspersed with the lower resolution images. An implementation of this method may be to capture one or more high resolution images, followed by a number of lower resolution images every second. Subsequently, also it will be possible to interlace lower resolution images to create a higher resolution image. For example, the lower resolution images are combined to form a higher resolution image in a technique analogous to that used in cathode ray televisions.

At step 32, the flight recorder control unit 6, determines if the current flight condition data exceeds any pre-set thresholds that would cause the conditions to be considered “out of normal”. If none of the pre-set thresholds are exceeded, then at step 33, the control unit 6 compares one or more of the flight conditions data obtained from the sensors 8 with -previously stored flight conditions data and determines if the flight conditions have altered significantly. The control unit 6 determines the degree of difference between the current flight conditions and the stored conditions.

If, at step 33, the control unit 6 determines that the stored flight conditions and the current flight conditions do not differ by a significant amount (for example by more than a predetermined threshold value) then the control unit instructs the camera unit 4 to continue obtaining images or a series of images of the instrument display panel 20 (step 35) at a low resolution/rate and at step 37 to continue reading the sensor data at a low rate and resolution.

Conversely, if the control unit 6 determines at step 32 that a pre-set threshold has been exceeded and current conditions are “out of normal”, or at step 33 that the stored flight conditions and the current conditions do differ by a significant amount (e.g. by more than the threshold value), then at step 34 the control unit dynamically changes the resolution (and/or image capture rate) of the camera unit 4 so that it obtains an image or a series of images at a higher resolution and/or rate. At step 36 the control unit 6 dynamically increases the rate and resolution at which the sensor data is read. For example the sensor data may be obtained at a 24-bit digital data format.

In the procedure described above, the images and sensor data obtained are stored in the data storage unit 9 and provide a record of the flight status data. A timestamp of the image and sensor data is also stored. The advantage of this procedure is that the size (amount) of the data stored as images in the data storage unit 9 is reduced. During normal flight conditions, the images are obtained at a low resolution or rate, most of the time, to reduce the amount of data stored. When the control unit 6 detects a change in the flight conditions (for example caused by an unexpected flight event) as detected by the sensors 8, the sensor data and images obtained by the camera unit 4 of the instrument display panel 20 are of a sufficiently high resolution and rate to ensure that the aircraft status data displayed by the instrument display panels 20 are easily discernable within the images and any rapid changes can be observed and analysed. This eliminates the need to provide either a multitude of sensors 8 within the flight recorder 1 or heavy and bulky interface cabling between the external sensors on the aircraft and the flight recorder 1 and reducing the cost associated with the installation. It also means that the size of the data storage memory in the flight recorder 1 can be kept relatively small. This also has the advantage of reducing the time required to download the acquired data.

As the overall size of the flight recorder 1 is partially determined by the size of data storage memory required, the use of smaller data storage memory units 9 allow smaller flight recorders l to be manufactured, increasing the positional versatility of the flight recorder 1.

It will be appreciated that, although the camera unit 4 is configured to dynamically change the resolution and/or the rate of the obtained images when a change in the flight conditions occurs, the control means 6 may alternatively or additionally instruct the camera unit 4 to obtain alternating high and low resolution images or image rates, or may set the variance of the resolution and/or rate of the images in a predetermined manner.

In order to maximise the likelihood of successfully recovering the data, multiple storage devices can be used as part of the data storage unit 9. Subsequent data elements or groups of data elements (sensor data or images) can be partitioned so that they are stored in different physical storage devices. As such, each storage device contains a complete and continuous record of the stored sensor data, audio and images but is at a slower recorded/update rate than is contained within all the storage devices combined. After an incident or accident, recovery of the data from all storage devices will allow recovery of all data, but in the event that one or more storage devices are damaged, one or more other storage devices will still contain a complete record, albeit at a lower update rate, of the events leading to the incident.

1. A flight recorder for an aircraft with an instrument display panel for displaying aircraft status data to a pilot, said flight recorder comprising:
one or more sensors that provide flight condition data of the aircraft;
a camera unit that provides image data;
a data storage unit storing the aircraft flight condition data and image data from the camera; and
a control unit that monitors the flight condition data supplied by the sensors.

2. A flight recorder according to claim 1, wherein the flight recorder is mountable within a cockpit area of the aircraft and the camera unit is configured to generate an image or a series of images of the instrument display panel and aircraft status data displayed thereupon.

3. A flight recorder according to claim 2, wherein the flight recorder is configured to dynamically change the resolution and/or the rate at which sensor data are read and recorded and/or at which the images or series of images are generated.

4. A flight recorder according to claim 3, configured to alter the resolution and/or the rate at which sensor data are read and recorded and/or at which the images or series of images are generated when the control unit detects a change to one or more of the flight condition data provided by the sensors.

5. A flight recorder according to claim 3, wherein the resolution and/or the rate at which the sensor data are read and recorded and/or at which the images or series of images are generated is altered when the control unit detects a change to one or more of the flight condition data obtained by the sensors of greater than a threshold value or range.

6. A flight recorder according to claim 4 wherein the resolution of the sensor data or generated images or series of images is altered from a lower resolution to a higher resolution and/or the rate of the sensor data or generated images or series of images is altered from a lower rate to a higher rate.

7. A flight recorder according to claim 1, wherein the sensor data is provided as digital data having a resolution determined by a number of bits of the digital format of the sensor data.

8. A flight recorder according to claim 1 further comprising an audio sensor for monitoring cockpit noise and/or an audio-input sensor for monitoring the audio stream from a headset.

9. A flight recorder according to claim 8 wherein the data storage unit stores the cockpit noise from the audio sensor and the headset audio stream from the audio-input sensor.

10. A flight recorder according to claim 1 wherein the data storage unit comprises multiple storage devices, wherein data elements or groups of data elements comprising sensor data or image data are partitioned and stored in different storage devices.

11. A flight recorder according to claim 10, wherein each storage device contains a complete and continuous record of the stored sensor, audio and image data but at a slower recorded rate than is contained within all the storage devices combined.

12. A flight recorder according to claim 1 wherein the sensor data is received by way of an external data link from sensors elsewhere on the aircraft

13. A method of recording aircraft flight data comprising the steps of:
providing a flight recorder unit, wherein the flight recorder unit contains a camera and a data storage unit for recording image data generated by the camera unit;
locating the flight recorder unit within a cockpit area of an aircraft; and
using the camera to generate an image or series of images of an instrument display panel and aircraft status data displayed thereupon.

14. The method of claim 13 additionally comprising:
dynamically altering the resolution of the generated image or series of images and/or dynamically altering the rate at which images are generated.

15. The method of claim 14 further comprising monitoring a flight condition of an aircraft from one or more sensors in the flight recorder.

16. The method of claim 15 further comprising:
detecting a change to one or more of the flight condition data; and
altering the resolution and/or the rate at which the flight condition data are monitored and/or the image or series of images are generated on detecting a change to one or more of the flight condition data obtained by the sensors.

17. The method of claim 16, comprising generating a lower resolution image or series of images and/or rate of images or series of images in the absence of a change to the one or more flight condition data and generating a higher resolution image or series of images and/or a higher rate of images or series of images when a change to the one or more flight condition data obtained by the sensors is detected.

18. The method of claim 16, including dynamically altering the resolution and/or the rate at which the sensor data are read and recorded when a change to one or more of the flight condition data obtained by the sensors is detected.

19. The method of claim 14 further comprising interspersing series of different resolution images.

20. The method of claim 13 further comprising interlacing the image data.

21. The method of claim 13 further comprising recording cockpit audio or noise by means of an audio sensor.

22. The method of claim 21 wherein the audio sensor is provided within the flight recorder unit.

23. The method of claim 13, wherein the data storage unit comprises multiple storage devices, the method further comprising partitioning sensor data and/or image data into data elements or groups of data elements and storing the data elements or groups in different storage devices.

24. The method of claim 23, comprising storing a complete and continuous record of the stored sensor, audio and image data in each storage device but at a slower recorded rate than is contained in the data stored in all the storage devices combined.

25. The method of claim 13, wherein the sensor data is received by way of an external data link from sensors elsewhere on the aircraft.
